(19) United States
(12) Patent Application Publication
(10) Pub. No.: US 2010/0187450 A1
(43) Pub. Date: Jul. 29, 2010

(54) MICROELECTRONIC SENSOR DEVICE WITH LIGHT SOURCE AND LIGHT DETECTOR

(75) Inventors: Josephus Arnoldus Henricus Maria Kahlman, Tilburg (NL); Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/665,068

(22) PCT Filed: Jun. 18, 2008
(86) PCT No.: PCT/IB08/52390

§ 371 Date: Dec. 17, 2009

(30) Foreign Application Priority Data
Jun. 21, 2007 (EP) 07110763.5

(51) Int. Cl. G01J 3/50; G01N 15/06; H01J 3/14

(52) U.S. Cl. 250/573; 250/216; 250/226

(57) ABSTRACT

The invention relates to a method and a microelectronic sensor device for making optical examinations in an investigation region (3). An input light beam (L1) is emitted by a light source (20) into said investigation region (3), and an output light beam (L2) coming from the investigation region (3) is detected by a light detector (30) providing a measurement signal (X). An evaluation unit (40) provides a result signal (R) based on a characteristic parameter (e.g. the intensity) of the input light beam (L1) and the output light beam (L2). Preferably, the input light beam (L1) is modulated with a given frequency (ω) and monitored with a sensor unit (22) that provides a monitoring signal (M). The monitoring signal (M) and the measurement signal (X) can then be demodulated with respect to the monitoring signal, and their ratio can be determined. This allows to obtain a result signal (R) that is largely independent of environmental influences and variations in the light source.

The invention relates to a microelectronic sensor device and a method for optical examinations in an investigation region of a carrier comprising the emission of light into the investigation region and the detection of light coming from the investigation region. Moreover, it relates to the use of such a sensor device.

The US 2005/0048599 A1 discloses a method for the investigation of microorganisms that are tagged with particles such that a (e.g. magnetic) force can be exerted on them. In one embodiment of this method, a light beam is directed through a transparent material to a surface where it is totally internally reflected. Light of this beam that leaves the transparent material as an evanescent wave is scattered by microorganisms and/or other components at the surface and then detected by a photodetector or used to illuminate the microorganisms for visual observation. A problem of this and similar measurement principles is that they are very sensitive to disturbances and variations in the light paths and the signal processing electronics. This is particularly true if the signal one is interested in is contained in small changes of a large base signal.

Based on this situation it was an object of the present invention to provide means for optical examinations in an investigation region comprising for example a biological sample. In particular, it is desirable that the measurement results have a high accuracy and robustness with respect to disturbances and/or variations of the system.

This object is achieved by a microelectronic sensor device according to claim 1, a method according to claim 14, and a use according to claim 15. Preferred embodiments are disclosed in the dependent claims.

The microelectronic sensor device according to the present invention is intended for making optical examinations in an investigation region of a carrier (which do not necessarily belong to the device). In this context, the term “examination” is to be understood in a broad sense, comprising any kind of manipulation and/or interaction of light with some entity in the investigation region, for example with biological molecules to be detected. The investigation region will typically be a small volume at the surface of the (preferably transparent) carrier in which material of a sample to be examined can be provided. The microelectronic sensor device comprises the following components:
a) A light source for emitting a light beam, called “input light beam” in the following, towards the investigation region, wherein said input light beam has a time-varying characteristic parameter. Many different examples of such a characteristic parameter can be considered in the context of the invention, an important one being the intensity of the light beam (defined as energy per unit time passing a cross section) in its whole spectrum or in a sub-range thereof. The light source may for example be a laser or a light emitting diode (LED), optionally provided with some optics for shaping and directing the input light beam.
b) A light detector for providing a signal, called “measurement signal” in the following, that is correlated to the characteristic parameter (i.e. the same type of parameter as for the input light beam) of a light beam coming from the investigation region, this beam being called “output light beam” in the following. The light detector may comprise any suitable sensor or plurality of sensors by which light of a given spectrum can be detected, for example a photodiode, a photo resistor, a photocell, or a photo multiplier tube.
c) An “evaluation unit” that provides a “result signal” based on the characteristic parameters of the input light beam and the output light beam. In particular, the result signal may correspond to the characteristic parameter of the output light beam normalized by the characteristic parameter of the input light beam. The evaluation unit is typically realized by dedicated electronic hardware, digital data processing hardware with associated software, or a mixture thereof. Moreover, it will usually get the measurement signal of the light detector as input.

The described microelectronic sensor device has the advantage to provide a result signal which is based on both the input light beam and the output light beam. The result signal can therefore be made independent of variations in the characteristic parameter of the input light beam, for example independent of intensity changes. Variations taking place in the light source are then no longer wrongly interpreted as processes occurring in the investigation region. Moreover, the temporal variations of the input light beam can be exploited to distinguish effects going back to the input light beam from effects going back to other origins, for example a changing ambient illumination.

The described microelectronic sensor device can be applied in a variety of setups and apparatuses. In a particular example, the output light beam that is detected by the light detector comprises light of the input light beam that was totally internally reflected in the investigation region. To this end, the investigation region must comprise an interface between two media, e.g. glass and water, at which total internal reflection (TIR) can take place if the incident light beam hits the interface at an appropriate angle (larger than the associated critical angle of TIR). Such a setup is often used to examine small volumes of a sample at the TIR-interface which are reached by exponentially decaying evanescent waves of the totally internally reflected beam. Target components—e.g. atoms, ions, (bio-)molecules, cells, viruses, or fractions of cells or viruses, tissue extract, etc.—that are present in the investigation region can then scatter the light of the evanescent waves which will accordingly miss in the reflected light beam. In this scenario of a “frustrated total internal reflection”, the output light beam of the sensor device will consist of the reflected light of the input light beam, wherein the small amount of light missing due to scattering of evanescent waves contains the desired information about the target components in the investigation region. Thus the signal one is interested in (missing light) is very small in comparison to a large base signal, making accurate measurements difficult. The proposed correlation of characteristic parameters of the input and the output light beam helps in this situation to make the results largely independent of the base signal.

In a preferred embodiment of the microelectronic sensor device, the light source comprises a sensor unit for providing a signal, which is called “monitoring signal” in the following, that is correlated to the characteristic parameter of the input light beam. Measuring the characteristic parameter of the input light beam directly (instead of e.g. deriving it from other signals or from theoretical considerations) provides information about this parameter with a high accuracy and authenticity in real-time. The monitoring signal is usually forwarded to the evaluation unit.

According to a further embodiment of the invention, the light source comprises a feedback control loop for controlling the characteristic parameter of the input light beam, wherein this loop may optionally comprise the aforementioned sensor unit. With the help of a feedback control, the light output of the light source can be stabilized to follow a well-defined (and known) temporal course.

In another embodiment of the invention, the light source comprises a “modulation unit” for controlledly modulating the characteristic parameter of the input light beam. The modulation may particularly take place according to a modulation signal, for example a sinusoidal signal of a given frequency. Modulating the light source in a known manner provides the input light beam with a kind of “fingerprint” that can be detected in the output light beam and help to discriminate effects of input light beam from other effects. Thus the accuracy and the robustness of the measurements can considerably be increased. The modulation unit may optionally be coupled to the evaluation unit for providing it with information about the temporal variation of the characteristic parameter of the input light beam.

The microelectronic sensor device may optionally comprise at least one high-pass filter for filtering the input signals of the evaluation unit, thus freeing them from low-frequency (DC) components in order to limit the dynamic range and required accuracy of the following components. One input signal of the evaluation unit is typically the measurement signal generated by the light detector (or some signal derived from it). Another input of the evaluation unit is typically a signal that provides information about the input light beam, for example the monitoring signal generated by a sensor unit in the light source as described above. Removing DC components from such input signals is particularly useful in the aforementioned case of a controlled modulation of the input light beam, because then only the modulated signal components enter the evaluation unit.

In the embodiment of a sensor device with a sensor unit in the light source, the evaluation unit preferably comprises a demodulator for demodulating the measurement signal and/or the monitoring signal with respect to a modulated component of the monitoring signal (e.g. the component that is generated by a modulation unit). By the demodulation those components of the measurement signal and/or the monitoring signal are extracted that are related to the modulation. This helps to discriminate effects that are actually caused by the (modulated) input light beam from artifacts in the signals that are due to other reasons. The demodulator may typically comprise a multiplier for multiplying the signal to be processed with the modulated component of the monitoring signal and a subsequent low-pass filter for removing time-varying components of the multiplication product.

In a further development of the aforementioned embodiment, the evaluation unit comprises a divider for determining the ratio between the demodulated measurement signal and the demodulated monitoring signal (or vice versa). This ratio can then be used as a result signal of the evaluation that is independent of the particular amplitude of the input light beam, or, in other words, that represents a normalized measurement signal of the light detector. In many situations, such a normalized signal represents the information one is actually interested in, for example the concentration of target components in the investigation region, and it is free from interferences from e.g. disturbances in the light path or the signal processing electronics.

In an optional embodiment of the invention, the evaluation unit comprises a multiplexing switch for alternately passing the monitoring signal or the measurement signal, respectively, to a shared processing hardware. Sharing some hardware reduces the costs of the device, and, most of all, eliminates the potential error source of random differences between two parallel hardware branches.

In a further development of the aforementioned embodiment, the evaluation unit comprises at least one storage unit for temporarily storing processing results of the shared hardware. In this way, the results of a previous processing step can be preserved for a correlation with the results of a subsequent processing step.

The evaluation unit may optionally comprise an analog-to-digital converter (ADC) for converting analog signals into digital signals for further processing. With other words, at least a part of the data processing in the evaluation unit is done digitally, which provides a high DC stability and avoids typical inaccuracies that can occur in analog processing hardware.

In an embodiment of the invention, the optical structure of the carrier comprises at least one facet, which will be called “excitation facet” in the following, via which light of an input light beam can be emitted into the adjacent sample chamber, and at least one corresponding facet, called “collection facet” in the following, via which the emitted light can be re-collected (as far as it could propagate undisturbed through the sample chamber). In this design, the space between the excitation facet and the collection facet constitutes the volume that is probed by the input light beam. Processes like absorption or scattering that take place in this volume will affect the amount and/or spectrum of light of the input light beam which can be re-collected at the collection facet. Said amount/spectrum therefore comprises information about such events and the substances causing them. In another configuration, e.g. using dark field detection in a direction perpendicular to the carrier, scattered and/or fluorescent light may be collected from the probe volume using both the excitation and collection facets.

The invention further relates to a method for making optical examinations in an investigation region of a carrier, said method comprising the following steps:
a) Emitting an “input light beam” with a time-varying characteristic parameter, e.g. intensity, towards the investigation region, wherein said emission may typically be done by a light source of the kind described above.
b) Providing a “measurement signal” that is correlated to the characteristic parameter of an “output light beam” coming from the investigation region, wherein said provision is typically done by a light detector of the kind described above.
c) Providing a “result signal” based on the characteristic parameters of the input light beam and the output light beam, wherein said provision is preferably done by an evaluation unit of the kind described above.

The method comprises in general form the steps that can be executed with a microelectronic sensor device of the kind described above. Therefore, reference is made to the preceding description for more information on the details, advantages and improvements of that method.

The invention further relates to the use of the microelectronic device described above for molecular diagnostics, biological sample analysis, or chemical sample analysis, food analysis, and/or forensic analysis. Molecular diagnostics may for example be accomplished with the help of magnetic beads or fluorescent particles that are directly or indirectly attached to target molecules.

These and other aspects of the invention will be apparent from and elucidated with reference to the embodiment(s) described hereinafter. These embodiments will be described by way of example with the help of the accompanying drawings in which:

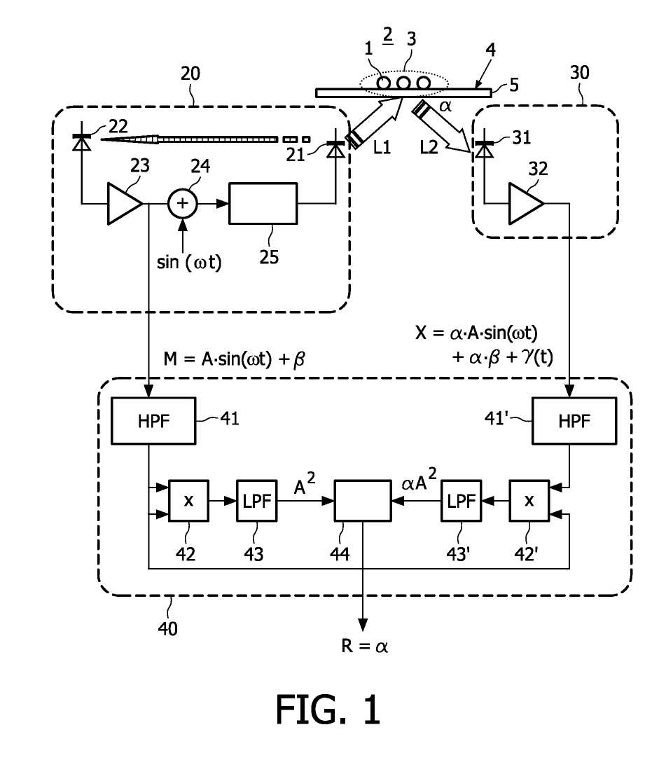

FIG. 1 illustrates a first embodiment of a microelectronic sensor device according to the present invention;

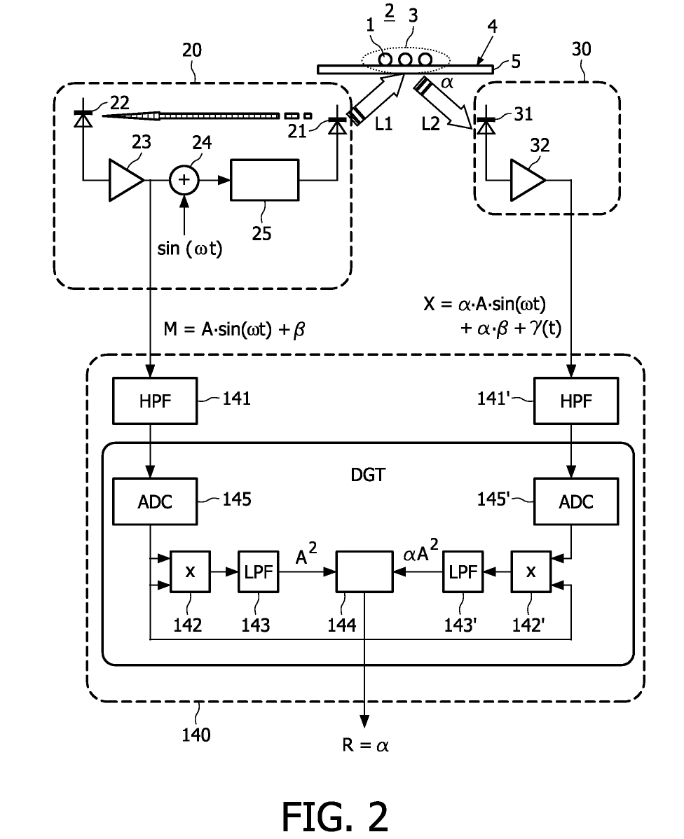

FIG. 2 shows a variant of the microelectronic sensor device of FIG. 1, in which the evaluation unit comprises circuitry for digital data processing;

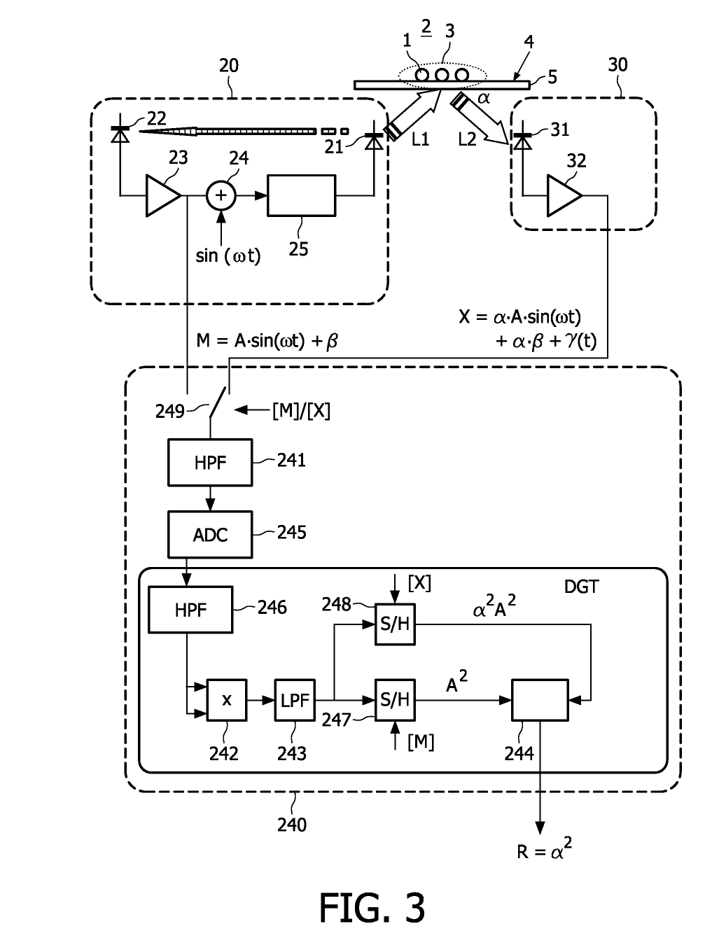

FIG. 3 shows a variant of the embodiment of FIG. 2, in which the parallel processing branches are replaced by a single branch and a multiplexing mechanism;

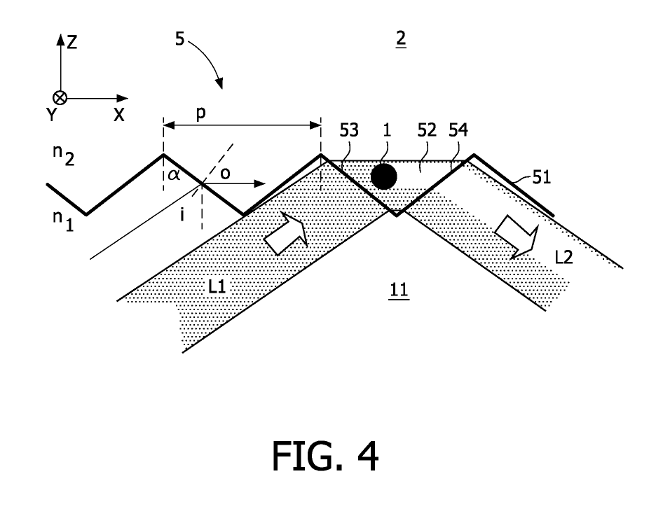

FIG. 4 shows an enlarged view of an alternative optical structure of the carrier;

Like reference numbers or numbers differing by integer multiples of 100 refer in the Figures to identical or similar components.

Though the present invention will in the following be described with respect to a particular setup (using magnetic particles and frustrated total internal reflection as measurement principle), it is not limited to such an approach and can favorably be used in many different applications and setups.

The microelectronic sensor device shown in the Figures comprises a light source 20 for emitting an “input light beam” L1, a light detector 30 for detecting and measuring an “output light beam” L2, and an evaluation unit 40 to which said two components are coupled. As is only schematically indicated in the Figures, the input light beam L1 is emitted into a (disposable) carrier 5 that may for example be made from glass or transparent plastic like poly-styrene. The carrier 5 is located next to a sample chamber 2 in which a sample fluid with target components to be detected (e.g. drugs, antibodies, DNA, etc.) can be provided. The sample further comprises magnetic particles 1, for example superparamagnetic beads, wherein these particles 1 are usually bound as labels to the aforementioned target components (for simplicity only the magnetic particles 1 are shown in the Figures). It should be noted that instead of magnetic particles other label particles, for example electrically charged of fluorescent particles, could be used as well.

The interface between the carrier 5 and the sample chamber 2 is formed by a surface called “binding surface” 4. This binding surface 4 may optionally be coated with capture elements, e.g. antibodies, which can specifically bind the target components.

The sensor device optionally comprises a magnetic field generator (not shown), for example an electromagnet with a coil and a core, for controllably generating a magnetic field at the binding surface 4 and in the adjacent space of the sample chamber 2. With the help of this magnetic field, the magnetic particles 1 can be manipulated, i.e. be magnetized and particularly be moved (if magnetic fields with gradients are used). Thus it is for example possible to attract magnetic particles 1 to the binding surface 4 in order to accelerate the binding of the associated target component to said surface.

The light source 20 comprises for example a laser or an LED 21 that generates the input light beam L1 which is transmitted into the carrier 5. The input light beam L1 arrives at the binding surface 4 at an angle larger than the critical angle of total internal reflection (TIR) and is therefore totally internally reflected as the output light beam L2. The output light beam L2 leaves the carrier 5 through another surface and is detected by a sensor 31 (e.g. a photodiode) followed by an amplifier 32 in the light detector 30. The light detector 30 thus determines a “measurement signal” X corresponding to the amount of light of the output light beam L2 (e.g. expressed by the light intensity of this light beam in the whole spectrum or a certain part of the spectrum). The measurement signal is further evaluated in the evaluation unit 40 that is coupled to the output of the light detector 30.

It is optionally possible to use the detector 30 (or a separate detector) for detecting fluorescence light emitted by fluorescent particles 1 which were stimulated by the evanescent wave of the input light beam L1.

The described microelectronic sensor device applies optical means for the detection of magnetic particles 1 and the target components one is actually interested in. For eliminating or at least minimizing the influence of background (e.g. of the sample fluid, such as saliva, blood, etc.), the detection technique should be surface-specific. As indicated above, this is achieved by using the principle of frustrated total internal reflection. This principle is based on the fact that an evanescent wave propagates (exponentially dropping) into the sample 2 when the incident light beam L1 is totally internally reflected. If this evanescent wave then interacts with another medium like the magnetic particles 1, part of the input light will be coupled into the sample fluid (this is called “frustrated total internal reflection”), and the reflected intensity will be reduced (while the reflected intensity will be 100% for a clean interface and no interaction). Depending on the amount of disturbance, i.e. the amount of magnetic beads on or very near (within about 200 nm) to the TIR surface (not in the rest of the sample chamber 2), the reflected intensity will drop accordingly. This intensity drop is a direct measure for the amount of bonded magnetic beads 1, and therefore for the concentration of target molecules. When the mentioned interaction distance of the evanescent wave of about 200 nm is compared with the typical dimensions of anti-bodies, target molecules and magnetic beads, it is clear that the influence of the background will be minimal. Larger wavelengths λ will increase the interaction distance, but the influence of the background liquid will still be very small.

The described procedure is independent of applied magnetic fields. This allows real-time optical monitoring of preparation, measurement and washing steps. The monitored signals can also be used to control the measurement or the individual process steps.

For the materials of a typical application, medium A of the carrier 5 can be glass and/or some transparent plastic with a typical refractive index of 1.52. Medium B in the sample chamber 2 will be water-based and have a refractive index close to 1.3. This corresponds to a critical angle θ_{c} of 60°. An angle of incidence of 70° is therefore a practical choice to allow fluid media with a somewhat larger refractive index (assuming n_{A}=1.52, n_{B} is allowed up to a maximum of 1.43). Higher values of n_{B} would require a larger n_{A} and/or larger angles of incidence.

Advantages of the described optical read-out combined with magnetic labels for actuation are the following:
Cheap cartridge: The carrier 5 can consist of a relatively simple, injection-molded piece of polymer material.
Large multiplexing possibilities for multi-analyte testing: The binding surface 4 in a disposable cartridge can be optically scanned over a large area. Alternatively, large-area imaging is possible allowing a large detection array. Such an array (located on an optical transparent surface) can be made by e.g. ink jet printing of different binding molecules on the optical surface. The method also enables high-throughput testing in well-plates by using multiple beams and multiple detectors and multiple actuation magnets (either mechanically moved or electro-magnetically actuated).
Actuation and sensing are orthogonal: Magnetic actuation of the magnetic particles (by large magnetic fields and magnetic field gradients) does not influence the sensing process. The optical method therefore allows a continuous monitoring of the signal during actuation. This provides a lot of insights into the assay process and it allows easy kinetic detection methods based on signal slopes.
The system is really surface sensitive due to the exponentially decreasing evanescent field.
Easy interface: No electrical interconnect between cartridge and reader is necessary. An optical window is the only requirement to probe the cartridge. A contact-less read-out can therefore be performed.
Low-noise read-out is possible.

In the described sensor device the typical ratio between the optical base line signal and the signal from the beads to be detected equals 4V/1 μV=4000000, wherein said optical base line signal originates from the large reflection at the TIR surface 4. Due to this large optical base line signal, gain variations originating from temperature effects (drift) in the sensor, in the signal processing path, and in the optical light path will introduce large variations in the detected signal, which limits the achievable accuracy and detection limit of the biosensor. This is especially a problem during relatively long-time measurements for low target-concentrations. In order to achieve 10% read-out accuracy, the sensor response must be kept stable within 0.1·1 μV/4V=25 ppm, which is difficult to realize. Furthermore spurious light sources from ambient and lighting, dark current in the photodiode and contact resistance (changes) may disturb the measurement.

It is therefore desirable to achieve a low detection limit and a high accuracy without introducing unrealistic demands on the stability of the optical light path and the signal processing electronics. The solution for this demand that is proposed here is based on a correlation between a characteristic parameter of the input light beam and the output light beam, for example the light beam intensities. A particular realization of this approach comprises modulating the light source amplitude in combination with a synchronous demodulation and normalizing on the applied wobble.

In the embodiment of FIG. 1, the aforementioned concept is realized with the help of a modulation unit 24 that is fed with a sinusoidal modulation signal sin(ωt). The modulation unit 24 is integrated into a closed control loop comprising:
the laser diode 21,
a photo diode 22 as sensor unit for measuring the intensity of the light beam L1 emitted by the laser diode 21,
an amplifier 23,
a summation node 24 at which the modulation signal is added to the output of the amplifier 23, and
a loop filter 25 which controls the laser diode 21 and which can be designed according to engineering principles known to a person skilled in the art.

The output of the light source 20 may for example be modulated with a wobble signal sin(ωt) of typically about 4 kHz, and be stabilized using the forward sense diode 22 with a typical control bandwidth of about 15 kHz.

The output of the amplifier 23 is branched off as a “monitoring signal” M and provided as a first input to the evaluation unit 40. This monitoring signal M has the general form

M=A·sin(ωt)+β,

wherein β summarizes all components of the input light beam L1 that do not depend on the modulation signal sin(ωt).

The measurement signal X of the light detector 30 has the general form

X=α·[A·sin(ωt)+β]+γ(t).

Here, α is the factor by which the amount of input light L1 is diminished in the investigation region 3 due to frustrated total internal reflection, i.e. the value that carries the desired information about the beads 1. Moreover, γ(t) summarizes the (largely unknown) influences and disturbances occurring in the light path of the input light beam L1 and the output light beam L2 and/or in the processing electronics, for example an additional light input by ambient light. The measurement signal X is provided as a second input to the evaluation unit 40.

The evaluation unit 40 comprises two largely symmetric signal processing branches for its input signals M and X. In the left branch of FIG. 1, the monitoring signal M is first sent to a high-pass filter 41 for removing DC components. Next, the high-pass filtered signal is demodulated with respect to sin(ωt) by first squaring it in the multiplication unit 42 and then removing the resulting AC components in a low-pass filter 43. The output of this demodulator 42, 43 then comprises only the squared amplitude A² (besides a constant factor) of the modulated component of the monitoring signal M, and substantially no contributions of its residual component β.

Similarly, the measurement signal X is processed in the right branch of the evaluation unit 40 sequentially by a high-pass filter 41′ and a demodulator comprising a multiplication unit 42′ and a low-pass filter 43′, yielding the value αA² (besides the same constant factor as in the left branch). It should be noted that the multiplication unit 42′ in the right branch does not determine the square of the filtered measurement signal X, but the product of said signal and the high-pass filtered monitoring signal M. The influence of the measurement signal component β and of the unknown disturbances that are represented by γ(t) are suppressed by the demodulation because they do not have the “right” frequency ω. The modulation of the light source 20 with sin(ωt) thus provides the input light with a kind of fingerprint that allows to discriminate effects going back to this light from other effects.

If the modulation signal sin(ωt) is provided to the evaluation unit, the multiplication units 42, 42′ could alternatively calculate (instead of M² and X·M) the products M·sin(ωt) and X·sin(ωt), respectively.

In a divider 44, the ratio of the demodulated signals A² and αA² is determined, yielding the factor α one is interested in as the “result signal” R of the evaluation unit 40. This result signal R is independent of the actual laser power as well as the wobble amplitude or wobble waveform. Moreover, ambient light has no influence on the result. A strong advantage of the proposed modulation scheme is that the actual wobble amplitude, which can vary e.g. due to temperature variations, is not affecting the end-result.

FIG. 2 shows an embodiment of the sensor device with an alternative realization of the evaluation unit 140. By introducing analog-to-digital converters (ADCs) 145 and 145′ behind the high-pass filters 141 and 141′, respectively, the signals are transformed into the digital domain. They can therefore be processed in a digital circuitry DGT that realizes the multiplication units 142, 142′, the low-pass filters 143, 143′, and the divider 144 by digital data processing hardware, e.g. a microprocessor with associated software. An advantage of this design is that it has an improved DC stability.

In the previous embodiments of the sensor device gain variations between the two processing branches of the evaluation units 40, 140 may introduce inaccuracy. FIG. 3 therefore shows a third embodiment of an evaluation unit 240 in which these branches are shared so that possible gain variations are the same for both signal paths.

Depending on its control input [M]/[X], a time-multiplexing switch 249 passes the monitoring signal M or the measurement signal X to a high-pass filter 241. The signal then passes an analog-to-digital converter 245, a further high-pass filter 246 (for removing an ADC offset), a multiplication unit 242, and a low-pass filter 243. If the monitoring signal M has been processed, the result A² is stored in a sample-and-hold storage unit 247; if the measurement signal X has been processed, the result α²A² is stored in a sample-and-hold storage unit 248. After normalization in the divider 244, the square of the optical transfer factor, α², appears as the result signal R.

An exemplary design of the optical structure on the surface of the transparent carrier 5 is shown in more detail in FIG. 4. This optical structure consists of wedges 51 with a triangular cross section which extend in y-direction, i.e. perpendicular to the drawing plane. The wedges 51 are repeated in a regular pattern in x-direction and encompass between them triangular grooves 52.

When the input light beam L1 (or, more precisely, a sub-beam of the whole input light beam L1) impinges from the carrier side onto an “excitation facet” 53 of a wedge 51, it will be refracted into the adjacent groove 52 of the sample chamber 2. Within the groove 52, the light propagates until it impinges onto an oppositely slanted “collection facet” 54 of the neighboring wedge. Here the input light that was not absorbed, scattered, or otherwise lost on its way through the sample chamber 2 is re-collected into the output light beam L2. Obviously the amount of light in the output light beam L2 is inversely correlated to the concentration of target particles 1 in the grooves 52 of the sample chamber.

As a result a thin sheet of light is propagating along the contact surface, wherein the thickness of this sheet is determined by the wedge geometry and the pitch p (distance in x-direction) of the wedges. A further advantage of the design is that illumination and detection can both be performed at the non-fluidics side of the carrier.

Given the refractive index n₁ of the carrier (e.g. made of plastic), the refractive index n₂ of the (bio-)fluid in the sample chamber, and the entrance angle i of the input light beam L1, the wedge geometry can be optimized such that (i) a maximum amount of light is refracted back towards the light detector; and (ii) a maximum surface area is probed by the “reflected” light beam in order to have optimum binding statistics (biochemistry).

In case of a symmetrical wedge structure the refracted ray in the groove 52 between two wedges 51, sensing refractive index n₂, should be parallel to the optical interface. With respect to the variables defined in FIG. 4, this means that

o=α.

Furthermore, in order to have a maximum “clear” aperture for the incoming input light beam, the angle α of the wedge structure should be equal to the entrance angle i of the input light beam:

i=α.

Introducing these two demands into the law of refraction,

n₁·sin(i−90°−α)=n₂·sin(o)

implies after some calculations that

$$sin ( α ) = \frac{{n}_{2}}{4 {n}_{1}} \pm \frac{1}{2} \sqrt{{( \frac{{n}_{2}}{2 {n}_{1 }} )}^{2} + 2}$$

For a plastic substrate with a refractive index n₁=1.6, and a water-like liquid with a refractive index of n₂ somewhere between 1.3 and 1.4, the optimum wedge angle α ranges between about 70° and 74°. An appropriate value for the pitch p of the wedges 51 is about 10 μm, giving a sample volume height of about 1.5 μm.

While the invention was described above with reference to particular embodiments, various modifications and extensions are possible, for example:
In addition to molecular assays, also larger moieties can be detected with sensor devices according to the invention, e.g. cells, viruses, or fractions of cells or viruses, tissue extract, etc.
The detection can occur with or without scanning of the sensor element with respect to the sensor surface.
Measurement data can be derived as an end-point measurement, as well as by recording signals kinetically or intermittently.

The particles serving as labels can be detected directly by the sensing method. As well, the particles can be further processed prior to detection. An example of further processing is that materials are added or that the (bio)chemical or physical properties of the label are modified to facilitate detection.
The device and method can be used with several biochemical assay types, e.g. binding/unbinding assay, sandwich assay, competition assay, displacement assay, enzymatic assay, etc. It is especially suitable for DNA detection because large scale multiplexing is easily possible and different oligos can be spotted via ink jet printing on the optical substrate.
The device and method are suited for sensor multiplexing (i.e. the parallel use of different sensors and sensor surfaces), label multiplexing (i.e. the parallel use of different types of labels) and chamber multiplexing (i.e. the parallel use of different reaction chambers).
The device and method can be used as rapid, robust, and easy to use point-of-care biosensors for small sample volumes. The reaction chamber can be a disposable item to be used with a compact reader, containing the one or more field generating means and one or more detection means. Also, the device, methods and systems of the present invention can be used in automated high-throughput testing. In this case, the reaction chamber is e.g. a well-plate or cuvette, fitting into an automated instrument.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A microelectronic sensor device for optical examinations in an investigation region (3) of a carrier (5), comprising
a) a light source (20) for emitting an input light beam (L1) with a time-varying characteristic parameter towards the investigation region (3);
b) a light detector (30) for providing a measurement signal (X) that is correlated to the characteristic parameter of an output light beam (L2) coming from the investigation region (3);
c) an evaluation unit (40, 140, 240) that provides a result signal (R) based on the characteristic parameters of the input light beam (L1) and the output light beam (L2).

2. The microelectronic sensor device according to claim 1,
characterized in that the characteristic parameter is the intensity of the associated light beam (L1, L2) in a given spectral range.

3. The microelectronic sensor device according to claim 1,
characterized in that the output light beam (L2) comprises light of the input light beam (L1) that was totally internally reflected in the investigation region (3).

4. The microelectronic sensor device according to claim 1,
characterized in that the light source (20) comprises a sensor unit (22) for providing a monitoring signal (M) that is correlated to the characteristic parameter of the input light beam (L1).

5. The microelectronic sensor device according to claim 1,
characterized in that the light source (20) comprises a feedback control loop (22, 23, 24, 25) for controlling the characteristic parameter of the input light beam (L1).

6. The microelectronic sensor device according to claim 1,
characterized in that the light source (20) comprises a modulation unit (24) for modulating the characteristic parameter of the input light beam (L1).

7. The microelectronic sensor device according to claim 1,
characterized in that it comprises a high-pass filter (41, 41′, 141, 141′, 241) for filtering the input signals of the evaluation unit (40, 140, 240).

8. The microelectronic sensor device according to claim 4,
characterized in that the evaluation unit (40, 140, 240) comprises a demodulator (42, 43, 42′, 43′, 142, 143, 142′, 143′, 242, 243) for demodulating the measurement signal (X) and/or the monitoring signal (M) with respect to a modulated component of the monitoring signal (M).

9. The microelectronic sensor device according to claim 8,
characterized in that the evaluation unit (40, 140, 240) comprises a divider (44, 144, 244) for determining the ratio of the demodulated monitoring signal (M) and the demodulated measurement signal (M).

10. The microelectronic sensor device according to claim 1,
characterized in that the evaluation unit (240) comprises a multiplexing switch (249) for alternately passing the monitoring signal (M) or the measurement signal (X) to a shared processing hardware (241-246).

11. The microelectronic sensor device according to claim 10,
characterized in that the evaluation unit (240) comprises a storage unit (247, 248) for temporarily storing processing results of the shared processing hardware (241-246).

12. The microelectronic sensor device according to claim 1,
characterized in that it comprises an analogue-to-digital converter (145, 145′, 245) for converting analogue signals into digital signals for further processing.

13. The microelectronic sensor device according to claim 1,
characterized in that the carrier (5) comprises at least one hole or groove (52) in the surface of the carrier (5), whereby the hole or groove (52) has a cross section with two oppositely slanted opposing facets (53, 54), particularly a triangular cross section.

14. A method for making optical examinations in an investigation region (3) of a carrier (5), comprising
a) emitting an input light beam (L1) with a time-varying characteristic parameter towards the investigation region (3);
b) providing a measurement signal (X) that is correlated to the characteristic parameter of an output light beam (L2) coming from the investigation region (3);
c) providing a result signal (R) based on the characteristic parameters of the input light beam (L1) and the output light beam (L2).

15. Use of the microelectronic sensor device according to claim 1 for molecular diagnostics, biological sample analysis, or chemical sample analysis.
